(19) United States
(12) Patent Application Publication
(10) Pub. No.: US 2014/0123080 A1
(43) Pub. Date: May 1, 2014

(54) Electrical Device, Touch Input Method And Control Method

(71) Applicant: Dayong Gan, Beijing (CN)

(72) Inventor: Dayong Gan, Beijing (CN)

(73) Assignees: BEIJING LENOVO SOFTWARE LTD., Haidian District, Beijing (CN); LENOVO (BEIJING) CO., LTD., Haidian District, Beijing (CN)

(21) Appl. No.: 14/124,793

(22) PCT Filed: Jun. 7, 2012
(86) PCT No.: PCT/CN2012/076586

§ 371 Date: Dec. 9, 2013

(30) Foreign Application Priority Data
Jun. 7, 2011 (CN) 201110150810.1
Jun. 7, 2011 (CN) 201210032004.9

(51) Int. Cl. G06F 3/0488

(52) U.S. Cl. CPC G06F 3/0488
USPC 715/863

(57) ABSTRACT

An electrical device, touch input method and a control method thereof are provided. The touch input method is applied to the electrical device. The electrical device includes a display unit and a touch sensing unit arranged on top of the display unit, the touch area of the touch sensing unit is overlaid with the display area of the display unit, the display is used to display objects of the electrical device in the display area, and the touch area is divided into a first area and a second area not overlaying with each other. The touch input method comprises: detecting a gesture input; determining the start point of the gesture input being in the first area or the second area; generating a system management command corresponding to the gesture input when the start point of the gesture input being determined in the second area; generating an object operation command used to operating the object corresponding to the gesture input when the start point of the gesture input being determined in the first area; and executing the system management command or the object operation command.

This application claims priority to International Application No. PCT/CN2012/076586 filed Jun. 7, 2012; Chinese Patent Appln. 201110150810.1 filed Jun. 7, 2011, and Chinese Patent Appln. 201210032004.9 filed Feb. 13, 2012, the entire contents of each are incorporated herein by reference.

This invention relates to a field of electrical device, and more particularly, the invention relates to an electrical device, and a touch input method and a control method thereof.

### BACKGROUND

In recent years, electrical devices with touch screen are rapidly developed. In such electrical devices, a touch sensing unit is generally arranged in stack above a display unit to form a touch display screen. By a user performing a gesture input such as touch or slide on the touch display screen, the electrical device is made to perform a corresponding operation.

Generally, when the user performs a slide operation, the position of a start point of the slide gesture on the touch display screen is arbitrary. For the existing electrical devices, no matter whether the start point of the slide gesture is at an edge of the touch display screen or a central area other than the edge, the electrical device will equally handle it. In other words, the electrical device will not perform different operations according to the different the start points of the slide gesture.

In addition, with development of the technology, processing ability of a processor is improved, and functions that can be provided by a portable electrical device for users are constantly increased. However, the type of the touch operation has a limit on the control type that can be performed by the user through the touch. Although in order to satisfy the continuous improvement of the requirement of touch control, many solutions have been proposed. For example, in these solutions, it is generally necessary for user to perform a relatively complex touch input, which demands the user a lot and may easily cause the misjudgment of the electrical device.

### SUMMARY

In view of the above cases, the invention provides an electrical device and a touch input method thereof, which can perform different operations in accordance with different slide gestures (more particularly, edge slide operation and center slide operation), so as to facilitate the user to issue various operation commands with simple gestures and improve the user's experience. In addition, an object of embodiments of the invention is to provide an electrical device and a control method which can be applied to the electrical device so as to solve the above problems.

According to an embodiment of the invention, there is provided a touch input method for a touch sensing unit, the touch sensing unit including an input area which is divided into a first area and a second area that are not overlapped with each other, and a first edge of the input area and a second edge of the second area being overlapped, wherein the second area can identify an input operation in which at least part of an operation object is in contact with the second edge, and the first area can identify an input operation in which the operation object is not in contact with the second edge, the touch input method comprising: detecting a gesture input; judging whether a start point of the gesture input is within the first area or the second area so as to generate a judgment result; generating a first command when the judgment result indicates that the start point of the gesture input is within the first area; generating a second command which is different from the first command when the judgment result indicates that the start point of the gesture input is within the second area; and executing the first command or the second command.

The first command refers to an object operation command corresponding to the gesture input, the object operation command being used for operating the object, and the second command refers to a system administration command corresponding to the gesture input.

An end point of the gesture input is within the first area or the second area when the start point of the gesture input is within the first area, or the end point of the gesture input is within the first area or the second area when the start point of the gesture input is within the second area.

The second area refers to the edge of the first area and surrounds the first area.

Said generating the system administration command corresponding to the gesture input further includes: identifying type of the gesture input; and generating a back command when the gesture input is identified to be a leftward slide operation in which the start point is within the second area.

The input gesture refers to a gesture coming from outside of the touch area of the touch sensing unit.

A length of the second border of the second area perpendicular to the first edge is less than a first distance and greater than a second distance, wherein when a physical touch imprint left by the finger is substantially identical to the first touch area sensed by the touch sensing unit, the touch sensing unit converts the first touch area to a first touch point and the distance from the first touch point to the first edge refers to the first distance, and when the physical touch imprint left by the finger is greater than the second touch area sensed by the touch sensing unit, the touch sensing unit converts the second touch area to a second touch point and the distance from the second touch point to the first edge refers to the second distance.

The distance value from the divided boundary of the second area and the first area to the first edge of the input area of the touch sensing unit is less than the distance value from the first touch point to the first edge of the input area of the touch sensing unit corresponding to a case in which the edge of the first touch area is tangent with the first edge of the input area of the touch sensing unit.

According to another embodiment of the invention, there is provided an electrical device comprising: a display unit for displaying an object of the electrical device on a display area; a touch sensing unit arranged above the display unit and used to detect a gesture input, a touch area of the touch sensing unit being overlapped with the display area of the display unit, the touch area being divided into a first area and a second area that are not overlapped with each other; a processor; wherein the processor is configured to: judge whether a start point of the gesture input is within the first area or the second area so as to generate a judgment result; generate a first command when the judgment result indicates that the start point of the gesture input is within the first area; generate a second command which is different from the first command when the judgment result indicates that the start point of the gesture input is within the second area; and execute the first command or the second command.

The first command refers to an object operation command corresponding to the gesture input, the object operation command being used for operating the object, and the second command is a system administration command corresponding to the gesture input.

The processor can be configured to: identify type of the gesture input; and generate a back command when the gesture input is identified to be a leftward slide operation in which the start point is within the second area.

In the electrical device according to the embodiment of the invention and the touch input method thereof, by detecting the position of the start point the user's slide gesture and performing different commands in accordance with difference of positions of start point, it is possible for the user to manipulate the electrical device so as to execute various commands more easily, thus user's experience is improved.

Another embodiment of the invention provides a control method for an electrical device. The electrical device includes a first area and a second area surrounding the first area, wherein the first area is of polygon shape and the second area is divided into a plurality of sub-areas in accordance with borders of the first area. The first area and the second area constitutes a touch sensing area corresponding to a touch sensing unit of the electrical device, the method comprising: detecting movement locus of an operating body; determining whether the movement locus passes through at least two sub-areas of the second area; determining, in a first instruction set of the electrical device, an instruction corresponding to a touch operation in accordance with the movement locus when the movement locus passes through at least two sub-areas of the second area; and determining, in a second instruction set of the electrical device, an instruction corresponding to the touch operation in accordance with the movement locus when the movement locus fails to pass through at least two sub-areas of the second area.

The step of detecting the movement locus of the operating body further includes: detecting a start position corresponding to a touch start point of the touch operation and an end position corresponding to a touch end point of the touch operation; and the step of determining whether the movement locus passes through at least two sub-areas of the second area further includes: in accordance with the start position and/or the end position, determining, in the touch start point and the touch end point, whether there exists a first touch point that is within a first sub-area of the second area and there exists a second touch point that is within a second sub-area of the second area; in accordance with the start position and the end position, determining, in the second instruction set of the electrical device, the instruction corresponding to the touch operation when there exists the first touch point that is within the first sub-area of the second area and there exists the second touch point that is within the second sub-area of the second area; and in accordance with the start position and the end position, determining, in the first instruction set of the electrical device, the instruction corresponding to the touch operation when there fails to exist the first touch point that is within the first sub-area of the second area and there does exist the second touch point that is within the second sub-area of the second area.

The touch operation is performed through one operation body; that in accordance with the start position and/or the end position, determining, in the touch start point and the touch end point, whether there exists the first touch point that is within the first sub-area of the second area and there exists the second touch point that is within the second sub-area of the second area includes: in accordance with the start position and the end position, determining whether the start position is within the first sub-area of the second area and whether the end position is within the second-area of the second area.

The touch operation is performed through a plurality of operation bodies at the same time; that in accordance with the start position and/or the end position, determining, in the touch start point and the touch end point, whether there exists the first touch point that is within the first sub-area of the second area and there exists the second touch point that is within the second sub-area of the second area includes: in accordance with the start position, determining, in the touch start point, whether there exists the first touch point that is within the first sub-area of the second area and there exists the second touch point that is within the second sub-area of the second area.

The touch operation is performed through a plurality of operation bodies at the same time; that in accordance with the start position and/or the end position, determining, in the touch start point and the touch end point, whether there exists the first touch point that is within the first sub-area of the second area and there exists the second touch point that is within the second sub-area of the second area includes: in accordance with the end position, determining, in the touch end point, whether there exists the first touch point that is within the first sub-area of the second area and there exists the second touch point that is within the second sub-area of the second area.

The first sub-area and the second sub-area are sub-areas adjacent to each other.

Another embodiment of the invention provides an electrical device comprising: a touch sensing unit configured to detect movement locus of operation body, wherein a touch sensing area of the touch sensing unit is divided into a first area and a second area, the second area surrounding the first area, wherein the first area is a polygon and the second area is divided into a plurality of sub-areas in accordance with borders of the first area; a locus determination unit configured to determine whether the movement locus passes through at least two sub-areas of the second area; a first introduction determination unit configured to determine, in a first instruction set of the electrical device, an instruction corresponding to the touch operation in accordance with the movement locus when the movement locus passes through at least two sub-areas of the second area; and a second introduction determination unit configured to determine, in a second instruction set of the electrical device, an instruction corresponding to the touch operation in accordance with the movement locus when the movement locus fails to pass through at least two sub-areas of the second area.

The touch sensing unit is configured to detect a start position corresponding to a touch start point of the touch operation and an end position corresponding to a touch end point of the touch operation; the electrical device further includes a position determination unit configured to determine, in the touch start point and the touch end point, whether there exists a first touch point that is within a first sub-area of the second area and there exists a second touch point that is within a second sub-area of the second area, in accordance with the start position and/or the end position; the second instruction determination unit is configured to determine, in the second instruction set of the electrical device, the instruction corresponding to the touch operation when there exists the first touch point that is within the first sub-area of the second area and there exists the second touch point that is within the second sub-area of the second area, in accordance with the start position and the end position; and the second instruction determination unit is configured to determine, in the first instruction set of the electrical device, the instruction corresponding to the touch operation when there fails to exist the first touch point that is within the first sub-area of the second area and there does exist the second touch point that is within the second sub-area of the second area, in accordance with the start position and the end position.

The touch operation is performed through one operation body; the position determination unit determines whether the start position is within the first sub-area of the second area and whether the end position is within the second-area of the second area, in accordance with the start position and the end position.

The touch operation is performed through a plurality of operation bodies at the same time; the position determination unit determines, in the touch start point, whether there exists the first touch point that is within the first sub-area of the second area and there exists the second touch point that is within the second sub-area of the second area, in accordance with the start position.

The touch operation is performed through a plurality of operation bodies at the same time; the position determination unit determines, in the touch end point, whether there exists the first touch point that is within the first sub-area of the second area and there exists the second touch point that is within the second sub-area of the second area, in accordance with the end position.

With the schemes provided by the embodiments of the invention described above, the type of the touch control command can be increased, so as to satisfy the user's demand of various operations. And by arranging the areas of the electrical device as the first area and the second area surrounding the first area, and dividing the second area into a plurality of sub-areas in accordance with borders of the first area, it is possible to reduce misjudgment of the electrical device to the user's touch input, and improve user's usage experience.

### BRIEF DESCRIPTION OF THE DRAWINGS

FIG. 1 is a diagram illustrating a flowchart of a touch input method according to an embodiment of the invention.

FIG. 2 is a diagram illustrating a flowchart of the touch input method according to another embodiment of the invention.

FIG. 3 is a block diagram illustrating a main configuration of the electrical device according to an embodiment of the invention.

FIG. 4 is a block diagram illustrating a main configuration of the electrical device according to another embodiment of the invention.

FIG. 5 is a block diagram illustrating a main configuration of the electrical device according to another embodiment of the invention.

FIG. 6A to FIG. 6C are diagrams schematically illustrating operations of an operation body on a touch display unit.

FIG. 7 is a diagram showing an example of basic structure of areas of the electrical device according to another embodiment of the invention.

FIG. 8 is a diagram describing a flowchart of the control method according to another embodiment of the invention.

FIG. 9 is an explanation diagram showing an exemplified case of determining, in the touch start point and the touch end point, whether there exists a first touch point that is within a first sub-area of the second area and there exists a second touch point that is within a second sub-area of the second area, in accordance with another example of the invention.

FIG. 10 is an explanation diagram showing an exemplified case of determining, in the touch start point and the touch end point, whether there exists a first touch point that is within a first sub-area of the second area and there exists a second touch point that is within a second sub-area of the second area, in accordance with another example of the invention.

FIG. 11 is an explanation diagram showing an exemplified case of determining, in the touch start point and the touch end point, whether there exists a first touch point that is within a first sub-area of the second area and there exists a second touch point that is within a second sub-area of the second area, in accordance with another example of the invention.

FIG. 12 is a diagram describing a flowchart of the control method according to another embodiment of the invention.

FIG. 13 is a block diagram showing exemplified structure of the electrical device according to an embodiment of the invention.

FIG. 14 is a block diagram showing exemplified structure of the electrical device according to an embodiment of the invention.

FIG. 15A and FIG. 15B are schematic diagrams showing user performing press operation at edge of a touch area when a second area is arranged to be narrow.

FIG. 16A and FIG. 16B are schematic diagrams showing user performing slide operation at edge of a touch area when a second area is arranged to be narrow.

### DETAILED DESCRIPTION

Hereinafter, embodiments of the present invention will be described in details with reference to the appended drawings.

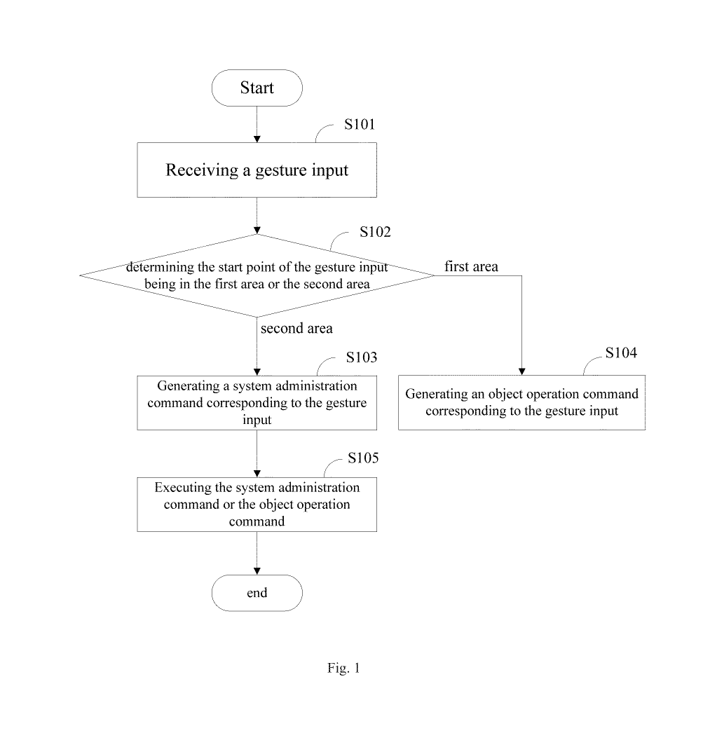

First, a touch input method according to an embodiment of the present invention will be described with reference to FIG. 1.

The touch input method according to the embodiment of the present invention can be applied to electrical device. The electrical device includes a display unit and a touch sensing unit, which are arranged in stack to form a touch display unit. For example, the touch sensing unit can be arranged above the display unit. The touch sensing unit is composed of a plurality of touch sensors arranged in arrays. A touch area of the touch sensing unit is overlapped with a display area of the display unit. In other words, the size of the touch area is same as that of the display area. The display unit is used to display objects in the electrical device on the display area. The objects can be such as picture, webpage, audio, application icon, display interface or the like. Of the above, the size of the display interface is greater than that of the display unit.

Further, the touch area is divided into a first area and a second area that are not overlapped with each other. For example, the second area is the edge area of the touch area. For example, the first area is the center area other than the edge area in the touch area, and the second area surrounds the first area. For example, in a case where the touch display unit is of rectangle shape, the second area is, for example, four edges of the touch display unit, and the first area is, for example, area other than the four edges in the touch display unit. More particularly, as described above, the touch sensing unit is composed of a plurality of touch sensors arranged in array. The first area has no cross point with the second area; that is to say, the touch sensor array of the first area does not share touch sensor with the touch sensor array of the second area. The second area for example corresponds to sensors which are located at periphery of the touch sensor array, and the first area for example corresponds to sensors which are located at center of the touch sensor array. The second area can be one area, and also can be one line. Alternatively, for example, the second area can be an area where the line and/or column sensors at the utmost outside in the touch sensor array are located, and the first area can be, for example, an area where the sensors other than the line and/or column sensors at the utmost outside are located.

As shown in FIG. 1, in the touch input method of the embodiment of the invention, first, at step S101, the touch input method detects a gesture input through the touch sensing unit.

Then, at step S102, the touch input method determines whether a start point of the gesture input is within the first area or the second area so as to generate a judgment result. Particularly, for example, the touch input method can sense a series of locus points of the gesture input through the touch sensing unit. Then, the touch input method uses a first locus point of the series of the locus points as the start point of the gesture input, and determines whether the start point is within the first area or the second area in accordance with the position of the start point, so as to obtain a judgment result.

When the judgment result indicates the start point of the gesture input is within the second area, the touch input method goes to step S103. At step S103, the touch input method generates a system administration command corresponding to the gesture input. The system administration command is used for managing system level operations; for example, the system administration command can be such as main interface command, task administrator command, back command, menu command or the like.

More particularly, the touch input method can identify type of the gesture input according to the locus points of the gesture input. The processing method thereof is known to those skilled in the art, and will not be described in details any more.

For example, in a case where the second area is four edges of the touch display unit, when the touch input method identifies that the gesture input is a slide operation of leftward slide from the right edge of the touch display unit to the left thereof, the touch input method generates a back command.

Still for example, when the touch input method identifies that the gesture input is a slide operation of rightward slide from the left edge of the touch display unit to the right thereof, the touch input method generates a task administrator command.

As another example, when the touch input method identifies that the gesture input is a slide operation of upward slide from the downward edge of the touch display unit to the upward thereof, the touch input method generates a menu command.

As still another example, when the touch input method identifies the gesture input is an operation of continuously sliding to the inside of the touch display unit twice from any of the edges of the touch display unit within a predetermined time, the touch input method generates the main interface command.

As still another example, when the touch input method identifies that the gesture input is a slide operation of which all the locus points are within the second area, it is also possible to generate a predetermined system administration command.

It should be pointed out that, the type of the gesture input, the type of the system administration command and corresponding relationship between the gesture input and the system administration command are only given as example. Those skilled in the art can properly make changes based thereon as necessary.

Further, it should be pointed out that, the description is made hereinbefore by taking the case where the second area is the four edges of the touch display unit as an example. Those skilled in art can understand that, the second area is not limited thereto, and can be any properly arranged areas. For example, the second area can be a block area in which a relatively long distance is extended from the respective edges of the touch display unit to inside thereof.

After the system administration command is generated at step S103, the touch input method goes to step S105.

When the judgment result indicates that the start point of the gesture input is within the first area, the touch input method goes to step S104. At step S104, the touch input method generates an object operation command corresponding to the gesture input. The object operation command is used to operate objects displayed on the display unit, such as webpage, image or widget (for example, notice column or icon of Android system), or display interface itself. For example, the object operation command can be object shift command, object zoom command, object display command or the like.

More particularly, the touch input method can identify type of the gesture input according to the locus points of the gesture input. The processing method thereof is known to those skilled in the art, and will not be described in details any more.

For example, in a case where one picture is displayed on the display unit, when the touch input method identifies that the gesture input is a slide operation of rightward slide in the first area, the touch input method generates a command for displaying next one of the pictures arranged in sequence.

Still, for example, in a case where the webpage is displayed on the display unit, when the touch input method identifies that the gesture input is a slide operation of downward slide in the first area, the touch input method generates a command for downward strolling and displaying the webpage.

It should be pointed out that, the type of the gesture input, the type of the object operation command and the corresponding relationship between the gesture input and the object operation command are only given as example. Those skilled in the art can properly make changes based thereon as necessary.

Further, it should be pointed out that, in the above description, only the case where it is judged that the start point of the gesture input is within the first area or the second area is described, and the end point for the gesture input is not limited. That is to say, for example, when the start point of the gesture input is within the second area, the end point of the gesture input can be within the first area, and also can be within the second area. Alternatively, for example, when the start point of the gesture input is within the first area, the end point of the gesture input can be within the first area, and also can be within the second area. For example, when the touch input method identifies that the gesture input is a slide operation that is always in the second area by a series of locus points including the start point and the end point, a corresponding system administration command can be generated. Still, for example, when the touch input method identifies by the locus points that the gesture input is a slide operation of sliding from the second area to the first area and then sliding to the second area in the same direction within a predetermined tine interval, the touch input method can generate the corresponding system administration command as well. Further, when the touch input method identifies by the locus points that the gesture input is a slide operation of sliding from the second area to the first area and then returning to the second area again in the opposite direction within a predetermined time interval, it is possible to generate the corresponding system administration command. Alternatively, in this case, the touch input method may not respond to this.

After the object operation command is generated at step S104, the touch input method goes to step S105.

At step S105, the touch input method executes the system administration command or the object operation command.

Hereinbefore, the touch input method according to the embodiment of the invention is described. By detecting the gesture input and in accordance with the start point of the gesture input being within the first area or the second area, different commands are generated. Thereby, after the user distinguishes the first area and the second area (especially center area and edge area) through simple study, it is possible to instruct the electrical device to execute different commands with simple operations, thus user's operation can be facilitated.

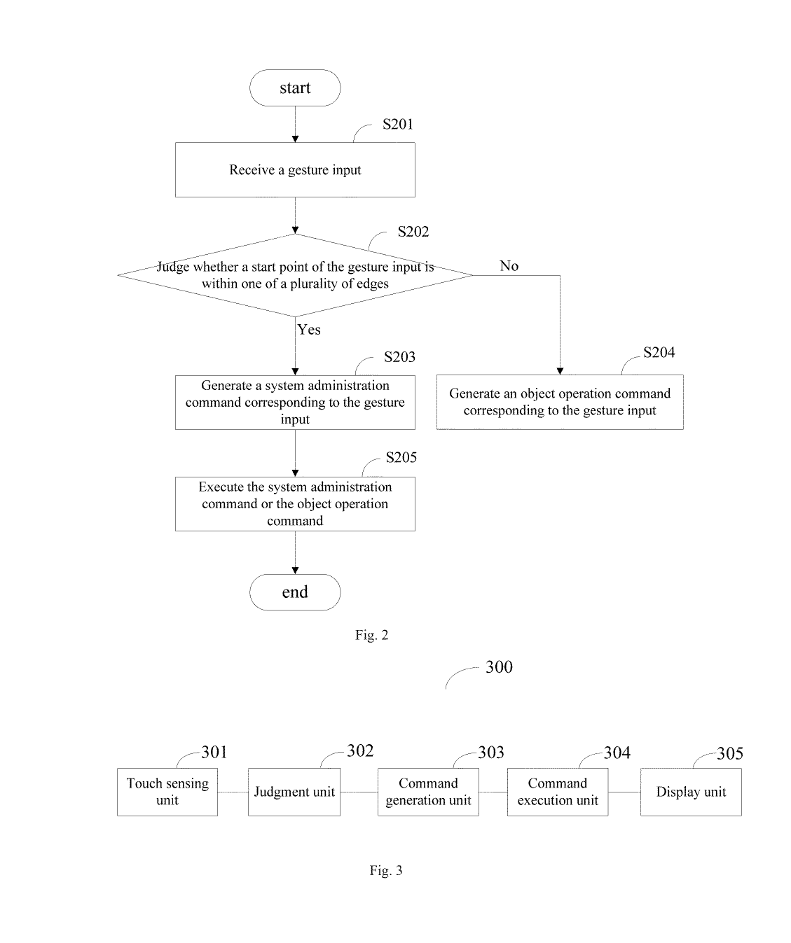

It should be pointed out that, in the touch input method of the above embodiments, the display unit and the touch sensing unit are arranged to be disposed in stack, and areas of the display unit and the touch sensing unit are of the same. However, the display unit and the touch sensing unit are not necessarily arranged to be disposed in stack, and it is not necessary for the area of the display unit to be same as that of the touch sensing unit. Hereinafter, operation of the touch input method according to another embodiment of the invention will be described with reference to FIG. 2.

In this embodiment, the electrical device includes a touch sensing unit composed of a plurality of touch sensor disposed in matrix. Further, the touch sensing unit has a touch input area. The touch input area includes a plurality of edges. For example, in a case where the touch input area is of rectangle shape, the touch input area includes four edges. Each of the edges corresponds to a line or a column of the touch sensors.

As shown in FIG. 2, at step S201, similarly to the operation of step S101, the touch input method detects a gesture input through the touch sensing unit.

At step S202, the touch input method judges whether the start point of the gesture input is within one of the plurality of edges, so as to generate a judgment result. Particularly, the touch input method performs the judgment through the touch sensor array. When the row or column of sensors at the utmost outside of the touch sensor array sense the gesture input, and other sensors other than said row or column of sensors fail to sense the gesture input, the touch input method determines the start point of the gesture input is within one of the plurality of the edges. When the row or column of sensors at the utmost outside of the touch sensor array fail to sense the gesture input, and any sensor other than said row or column of sensors senses the gesture input, the touch input method determines the start point of the gesture input is not within one of the plurality of the edges.

When the judgment result indicates the start point of the gesture input is within one of the plurality of the edges, the touch input method goes to step S203. At step S203, similarly to the operation of step S103, the touch input method generates a system administration command corresponding to the gesture input. Then, the touch input method goes to step S205.

When the judgment result indicates the start point of the gesture input is not within any of the plurality of the edges, the touch input method goes to step S204. At step S204, similar to the operation of step S104, the touch input method generates an object operation command corresponding to the gesture input. Then, the touch input method goes to step S205.

At step S205, similarly to the operation of step S105, the touch input method executes the system administration command or the object operation command.

With the touch input method of the embodiment of the invention, the user can instruct the electrical device to execute different commands through two different operations of the edge slide operation and the center slide operation, thus user's operation can be facilitated. Further, it should be pointed out that, in the touch input method of the embodiment of the invention, it is not necessary for the display unit and the touch sensing unit to be disposed in stack, and area of the display unit is not necessary to be the same as that of the touch sensing unit. Furthermore, it is not necessary for the electrical device itself to include the display unit.

Hereinabove, the touch input method according to the embodiment of the invention is described. Hereinafter, the electrical device according to embodiment of the invention will be described with reference to FIG. 3 to FIG. 5.

As shown in FIG. 3, the electrical device according to the embodiment of the invention includes a display unit 305 for displaying an object in the electrical device on a display area. The electrical device 300 further includes a touch sensing unit 301, a judgment unit 302, a command generation unit 303 and a command execution unit 304.

Of the above, the touch sensing unit 301 detects a gesture input. For example, the touch sensing unit can detect a series of locus points, so as to identify and detect the gesture input. Further, it should be pointed out that, the touch sensing unit 301 can be arranged above the display unit; the touch area of the touch sensing unit coincides with the display area of the display unit, and the touch area is divided into a first area and a second area which are not overlapped with each other.

The judgment unit 302 determines whether a start point of the gesture input is within the first area or the second area so as to generate a judgment result. Particularly, for example, after the detection unit 301 sensed a series of locus points of the gesture input, the judgment unit 302 uses a first locus point of the series of the locus points as the start point of the gesture input, and determines whether the start point is within the first area or the second area according to the position of the start point, so as to obtain a judgment result.

When the judgment result indicates the start point of the gesture input is within the second area, the command generation unit 303 generates a system administration command corresponding to the gesture input. When the judgment result indicates the start point of the gesture input is within the first area, the command generation unit 303 generates an object operation command corresponding to the gesture input; wherein the object operation command is used for operating the objects.

Of the above, the system administration command are used for managing system level operation; for example, the system administration command can be such as main interface command, task administrator command, back command, menu command or the like.

More particularly, the command generation unit 303 can include an identification unit for identifying type of the gesture input according to the locus points of the gesture input. The processing method thereof is known to those skilled in the art, and will not be described in details any more. Further, the command generation unit 303 can further include a plurality of units such as main interface command generation unit, task administrator command generation unit, back command generation unit, and menu command generation unit.

For example, in a case where the second area is four edges of the touch display unit, when the identification unit identifies that the gesture input is a slide operation of leftward slide from the right edge of the touch display unit to the left thereof, the back command generation unit generates a back command. Still for example, when the identification unit identifies that the gesture input is a slide operation of rightward slide from the left edge of the touch display unit to the right thereof, the task administrator command generation unit generates a task administrator command.

As another example, when the identification unit identifies that the gesture input is a slide operation of upward slide from the downward edge of the touch display unit to the upward thereof, the menu command generation unit generates a menu command.

As still another example, when the identification unit identifies the gesture input is an operation of continuously sliding to the inside of the touch display unit twice from any edge of the touch display unit within a predetermined time, the main interface command generation unit generates the main interface command.

It should be pointed out that, the type of the gesture input, the type of the system administration command and the corresponding relationship between the gesture input and the system administration command are only given as example. Those skilled in the art can properly make changes based thereon as necessary.

Further, the input gesture can be a gesture coming from outside of the touch area of the touch sensing unit. Since the operation body such as the finger of user or the like can not be detected before contacting with the touch sensing area of the touch sensing unit, it is possible to determine that the input gesture is a gesture coming from outside of the touch sensing area of the touch sensing unit in a way of detecting the edge of the touch sensing area of the touch sensing unit.

For example, it is possible to judge current mode of the electrical device (such as disposed in vertical direction or in horizon direction) through a gravity sensor or the like arranged on the electrical device. Then, a corresponding command can be generated by judging a position of the edge where the gesture input of the user comes from. For example, when it is judged that the electrical device is in a vertical mode, it indicates that the user is holding the electrical device with the hand. Then, when it is judged that the gesture input of the user comes from the right edge, a back command can be generated by the back command generation unit. When coming from the left edge, the task administrator command can be generated by the task administrator command generation unit. It equivalents to define in advance a system administration command, such as an instruction for returning to the main interface or the like, triggered when each edge of the touch sensing area of the touch sensing unit is touched. In this embodiment, the electrical device stores in advance two kinds of corresponding relationships, and the first one is the system administration command triggered in vertical screen when each of the edges of the touch sensing area is touched; the second one is the system administration command triggered in horizon screen when each of edges of the touch sensing area is touched. Thus it is guaranteed that no matter the user put the electrical device in horizon screen or vertical screen, the same system administration command will be triggered as long as the user comes from the right edge. Further, it should be pointed out that, hereinabove, a description is made by taking a case where the second area is four edges of the touch display unit as the example. Those skilled in the art can understand that, the second area is not limited thereto, and can be any properly arranged area. For example, the second area can be a block area in which a relatively long distance is extended from the respective edges of the touch display unit to inside thereof.

On the other hand, when the judgment result indicates that the start point of the gesture input is within the first area, the command generation unit 303 generates an object operation command corresponding to the gesture input. The object operation command is used to operate objects displayed on the display unit, such as webpage, image or widget (for example, notice column or icon of Android system). For example, the object operation command can be object shift command, object zoom command, object display command or the like. Correspondingly, the command generation unit 303 can include a plurality of units such as object shift command generation unit, object zoom command generation unit, object display command generation unit or the like.

For example, in a case where one picture is displayed on the display unit, when the identification unit identifies that the gesture input is a slide operation of rightward slide in the first area, the object shift command generation unit generates a command for displaying next one of the pictures arranged in sequence.

Still for example, in a case where webpage is displayed on the display unit, when the identification unit identifies that the gesture input is a slide operation of downward slide in the first area, the object shift command generation unit generates a command for downward strolling and displaying the webpage.

It should be pointed out that, the type of the gesture input, the type of the object operation command and the corresponding relationship between the gesture input and the object operation command are only given as example. Those skilled in the art can properly make changes based thereon as necessary.

Further, it should be pointed out that, in the above description, only the case where it is judged that the start point of the gesture input is located in the first area or the second area is described, and the end point for the gesture input is not limited. That is to say, for example, when the start point of the gesture input is located in the second area, the end point of the gesture input can be located in the first area, and also can be located in the second area.

The command execution unit 304 executes the system administration command or the object operation command. Of course, the execution result of the system administration command or the object operation command can be displayed on the display unit 305.

Hereinabove, the electrical device according to embodiment of the invention is described. With the electrical device, user can instruct the electrical device to execute different commands with the same operation in which the start points are different (for example, at the second area and the first area respectively), thus the user's operation can be facilitated.

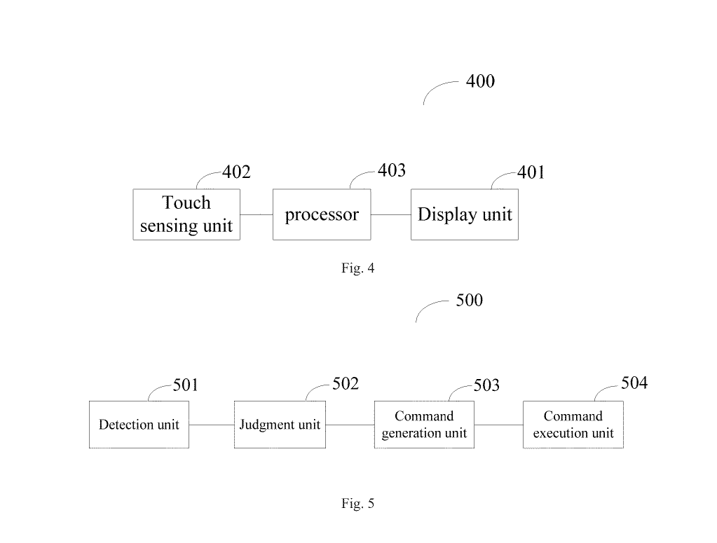

Hereinafter, the electrical device according to another embodiment of the invention will be described with reference to FIG. 4. As shown in FIG. 4, the electrical device 400 includes a display unit 401, a touch sensing unit 402 and a processor 403.

Of the above, the display unit 401 is used to display the objects in the electrical device on the display area.

The touch sensing unit 402 is arranged above the display unit, and used to detect a gesture input; the touch area of the touch sensing unit coincides with the display area of the display unit, and the touch area is divided into a first area and a second area that are not overlapped with each other.

The processor 403 is coupled with the touch sensing unit 402 and the display unit 401, and configured to perform the following operations: judging whether a start point of the gesture input is located at the first area or the second area based on the detection result by the touch sensing unit 402, so as to generate a judgment result; generating a system administration command corresponding to the gesture input when the judgment result indicates that the start point of the gesture input is located within the second area; generating an object operation command corresponding to the gesture input when the judgment result indicates that the start point of the gesture input is located within the first area, wherein the object operation command being used to operate the object; and executing the system administration command or the object operation command. The execution result of the system administration command or the object operation command can be displayed on the display unit 301.

Hereinabove, the electrical device according to the embodiment of the invention is described. With the electrical device, user can instruct the electrical device to execute different commands with the same operation in which the start points are different (for example, at the second area and the first area respectively), thus the user's operation can be facilitated.

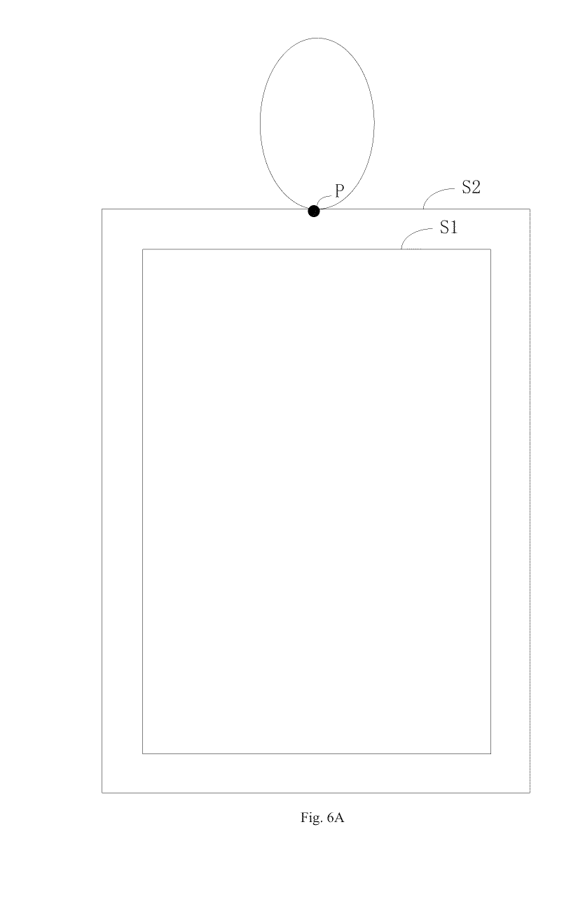

It should be pointed out that, in the electrical device of the above embodiment, the display unit and the touch sensing unit are arranged to be disposed in stack, and areas of the display unit and the touch sensing unit are of the same. However, the display unit and the touch sensing unit are not necessarily arranged to be disposed in stack, and area of the display unit is not necessarily same as that of the touch sensing unit. Furthermore, it is not necessary to include the display unit. Hereinafter, the electrical device according to another embodiment of the invention will be described with reference to FIG. 5. In the electrical device of this embodiment, the electrical device includes a touch sensing unit composed of a plurality of touch sensor disposed in matrix. Further, the touch sensing unit has a touch input area. The touch input area includes a plurality of edges. For example, in a case where the touch input area is of rectangle shape, the touch input area includes four edges. Each of the edges corresponds to a row or a column of touch sensors.

As shown in FIG. 5, the electrical device 500 includes a detection unit 501, a judgment unit 502, a command generation unit 503 and a command execution unit 504.

The detection unit 501 is the above touch sensing unit, and can be composed of a plurality of touch sensors disposed in matrix. The detection unit 501 detects a gesture input through the plurality of touch sensors.

The judgment unit 502 judges whether the start point of the gesture input is within one of the plurality of edges, so as to generate a judgment result. Particularly, when the row or column of sensors at the utmost outside of the touch sensor array of the detection unit 501 sense the gesture input, and sensors other than said row or column of sensors fail to sense the gesture input, the judgment unit 502 judges the start point of the gesture input is located within one of the plurality of the edges. When the row or column of sensors at the utmost outside of the touch sensor array of the detection unit 501 fail to sense the gesture input, and any one of the sensors other than said row or column of sensors senses the gesture input, the judgment unit 502 judges the start point of the gesture input isn't located within one of the plurality of the edges.

When the judgment result indicates the start point of the gesture input is located within one of the plurality of the edges, the command generation unit 503 generates a system administration command corresponding to the gesture input; when the judgment result indicates the start point of the gesture input is not located within any of the plurality of the edges, the command generation unit 503 generates an object operation command corresponding to the gesture input, wherein the object operation command is used to operate the objects. The configuration and operation of the command generation unit 503 are similar to those of the command generation unit 303, and will not be described in details any more.

The command execution unit 504 executes the system administration command or the object operation command. The configuration and operation of the command execution unit 504 are similar to those of the command execution unit 304, and will not be described in details any more.

With the electrical device of the embodiment of the invention, the user can instruct the electrical device to execute different commands through two different operations of the edge slide operation and the center slide operation, thus user's operation can be facilitated. Further, it should be pointed out that, in the electrical device of the embodiment of the invention, it is not necessary for the display unit and the touch sensing unit to be disposed in stack, and the area of the display unit is not necessarily to be the same as that of the touch sensing unit. Furthermore, it is not necessary for the electrical device itself to include the display unit.

Hereinafter, the touch input method according to another embodiment of the invention will be described. The touch input method is used for touch sensing unit. The touch sensing unit has an input area. The input area is divided into a first area and a second area that are not overlapped with each other, and the first edge of the input area coincides with the second edge of the second area.

Further, the second area can identify input operation of at least part of the operation body contacting with the second edge, and the first area can identify input operation of the operation body not contacting with the second edge.

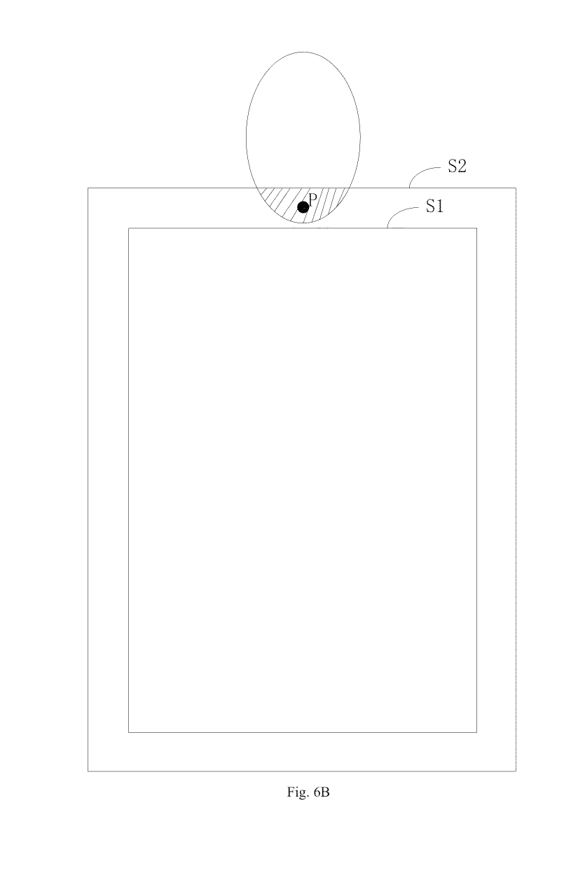

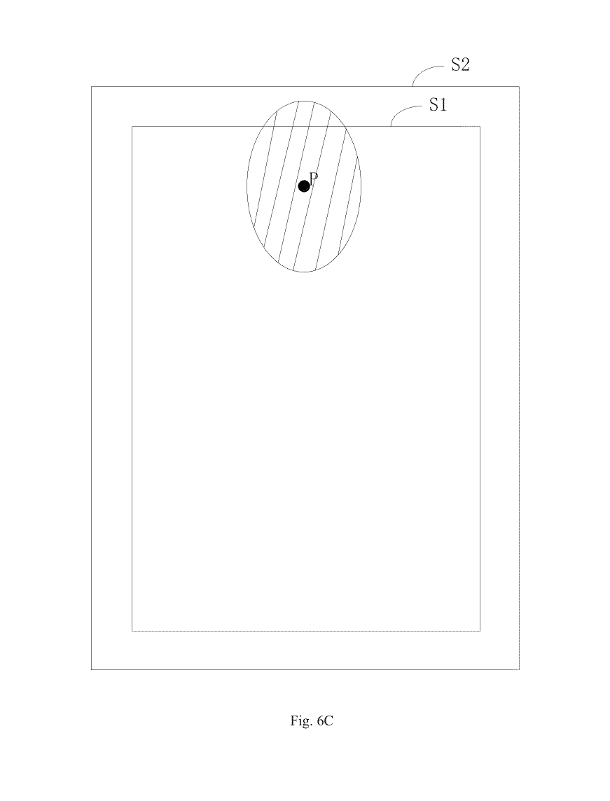

Hereinafter, the operations that can be identified by the second area and the first area will be described with reference to FIG. 6A to FIG. 6C. FIG. 6A to FIG. 6C schematically show a diagram of operations of the operation body in three case by taking the finger as example; wherein the elliptical area indicates the user's finger, and the rectangle area surrounded by solid line is the input area of the touch sensing unit, which is divided into two areas by broken line, that is, the first area S1 surrounded by broken line, and the second area S2 sandwiched by broken line and solid line. Further, the hatched part is the contact area of the finger with the touch sensing unit, and the letter P is the touch point of the finger identified by the touch sensing unit.

In FIGS. 6A to 6C, FIGS. 6A and 6B illustrate operations that can be identified by the second area, and FIG. 6C illustrates operation that can be identified by the first area. In case of FIG. 6A, the finger contacts the edge of the touch sensing unit from the outside of the touch sensing unit, and then slides to inside thereof (not shown). At this moment, the contact area of the finger with the touch sensing unit is only one point, and the touch sensing unit identifies this point to be the touch point of the finger, that is point P. The point P is located at the edge of the touch sensing unit, and the edge is contained in the second area. In case of FIG. 6B, the finger contacts the touch sensing unit from the edge of the touch sensing unit. At this moment, the contact area of the finger with the touch sensing unit is the hatched area as shown in the drawing, and the touch point P of the finger identified by the touch sensing unit is also located within the second area. In case of FIG. 6C, the finger contacts the touch sensing unit without cross the edge of the touch sensing unit. At this moment, the contact area of the finger with the touch sensing unit is the hatched area as shown in the drawing, and the touch point P of the finger identified by the touch sensing unit is located within the first area.

In the touch input method, first, a gesture input is detected. Then, it is determined whether the start point of the gesture input is located within the second area, so as to generate a judgment result. When the judgment result indicates the start point of the gesture input is located within the first area, a first command is generated, and when the judgment result indicates the start point of the gesture input is within the second area, a second command which is different from the first command is generated. Then, the touch input method executes the first command or the second command. The operations of the respective steps are similar to those of the above embodiments, and will not be described in details any more.

When the user performs touch on the touch area of the touch sensing unit of the electrical device with the finger, the touch imprint left by the finger is substantially identical to the touch area c corresponding to the physical touch imprint left by the finger sensed by the touch area, that is, the physical touch imprint is totally located within the touch area, as shown in FIG. 6c; the touch sensing unit converts the touch area c into the first touch point, wherein the distance from the first touch point to the first edge is the first distance. When the finger slides into the touch area from outside as shown in FIG. 6a, the edge of the touch area (the upper edge shown in the FIG. 6a) senses the second touch point, and when the finger presses the edge of the touch area and then slides into the touch area from the edge as shown in FIG. 6b, since the finger is divided by the edge of the touch area, touch area can sense the touch area b corresponding to the finger; this touch area b is less than the area of the finger, or the touch area b is less than the physical touch imprint left by the finger on the electrical device. The touch sensing unit converts the touch area b to the second touch point (as shown in FIG. 6b), and the distance from the second touch point to the first edge is the second distance, wherein a length of the second border of the second area which is perpendicular to the first edge is less than the first distance and greater than the second distance. Of the above, the touch sensing unit is a sensing lattice formed by a plurality of sensing units, wherein the edge of the touch area is formed by a circle (N) of sensing units at utmost outside of the touch sensing unit (that is, the outer edge of the touch area of the touch sensing unit), and wherein the touch area further includes a circle (N−1) of sensing units which are adjacent to but do not intersect the circle of sensing units at utmost outside; wherein the divided boundary of the second area and the first area are such that the physical touch imprint of the finger is totally located within the touched area and the touch sensing unit senses the touch area c corresponding to the physical touch imprint of the finger, the edge of the touch area c being tangent with the first border of the Nth circle of sensing unit of the touch sensing unit, the touch sensing unit converting the touch area c to the first touch point, and the length value of the second border of the second area which is vertical to the first edge is less than the distance value from the first touch point to the first border of the Nth circle (that is, the first edge of the touch area of the touch sensing unit). That is to say, the distance value from the divided boundary of the second area and the first area to the first edge of the touch area of the touch sensing unit is less than the distance value from the first touch point to the first edge of the touch area of the touch sensing unit corresponding to a case where the edge of the touch area c is tangent with the first edge of the touch area of the touch sensing unit.

Hereinabove, the electrical device according to the embodiment of the invention and the touch input method thereof are described with reference to FIG. 1 to FIG. 6. The above embodiments described the touch operation for the single edge, and in practical operation, there may exist the touch operation crossing two edges.

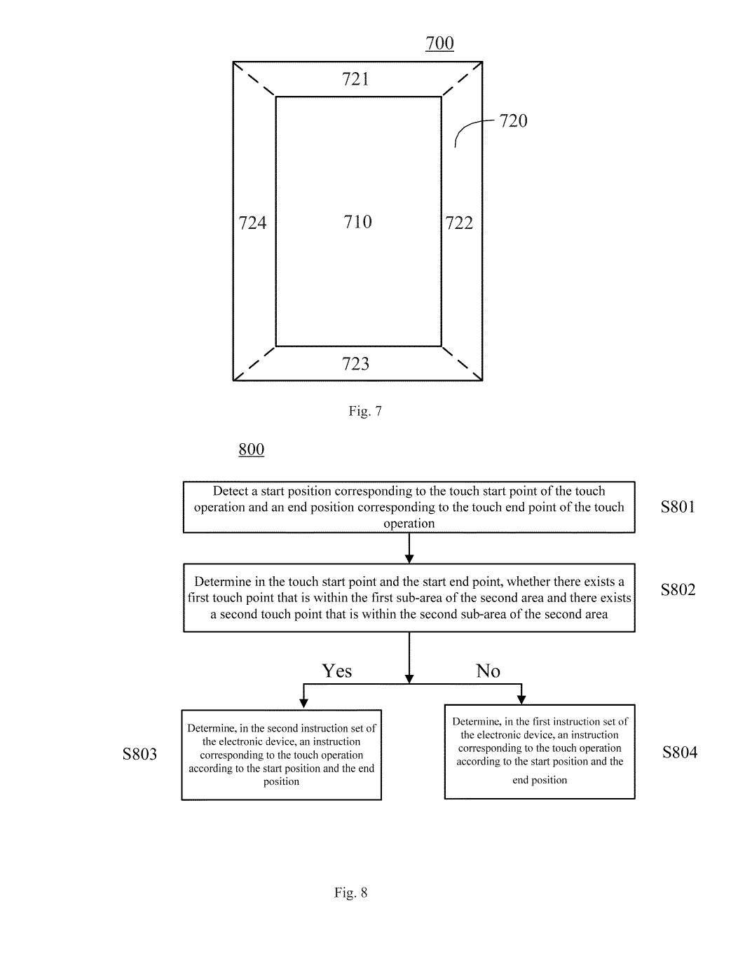

Hereinafter, the control method according to another embodiment of the invention and the electrical device thereof will be described with reference to FIG. 7 to FIG. 12. In the following embodiment of the invention, the electrical device refers to a device that can communicate with other devices. The specific form of the electrical device includes, but not limited to mobile phone, personal digital assistance, portable computer, tablet computer, game machine, music player or the like.

It should be explained that, the contents about the arrangement of the divided boundary line of the second area and the first area described hereinbefore also can be applied to the control method and the electrical device according to another embodiment of the invention described hereinafter.

FIG. 7 shows an example of basic construction of the area of electrical device 700 according to one embodiment of the invention. As shown in FIG. 7, the electrical device 700 includes a first area 710 and a second area 720 surrounding the first area 710. As shown in FIG. 7, the second area is divided into sub-areas 721 to 724 in accordance with borders of the first area. It should be noted that, although the first area 710 of the example shown in FIG. 7 is of rectangle shape, the invention is not limited thereto. The first area also can be of other polygon shape such as triangle, pentagon, hexagon or the like. The second area can be divided into a plurality of sub-area in accordance with borders of the first area.

FIG. 8 is a diagram describing a flowchart of a control method 800 according to one embodiment of the invention. Hereinafter, the control method according to one embodiment of the invention will be described with reference to FIG. 8. The control method 800 can be applied to the electrical device shown in FIG. 7.

As shown in FIG. 8, at step S801, start positions corresponding to touch start point of the touch operations and end positions corresponding to touch end point of the touch operations are detected. Then, at step S802, in accordance with the start position and/or the end position detected at step S801, whether there exists a first touch point that is within a first sub-area of the second area and there exists a second touch point that is within a second sub-area of the second area are determined in the touch start point and the touch end point.

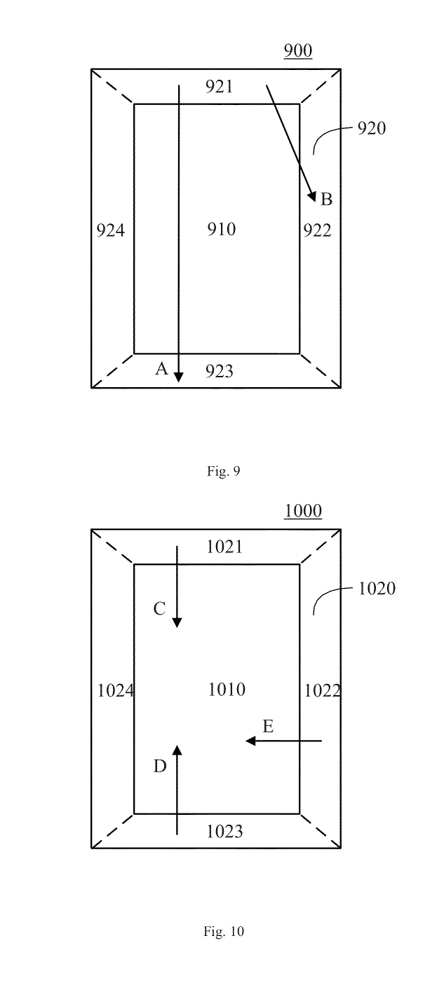

FIG. 9 is a schematic diagram showing an exemplified case of in accordance with one example of the invention, determining, in the touch start point and the touch end point, whether there exists a first touch point that is located within a first sub-area of the second area and there exists a second touch point that is located within a second sub-area of the second area. Similarly to the electrical device 700 shown in FIG. 7, the electrical device 900 includes a first area 910 and a second area 920 surrounding the first area 910. As shown in FIG. 9, the second area is divided into sub-areas 921 to 924 in accordance with borders of the first area.

In the example shown in FIG. 9, the touch operation can be performed through one operation body. That in accordance with the start positions and/or the end positions, determining, in the touch start point and the touch end point, whether there exists a first touch point that is within a first sub-area of the second area and there exists a second touch point that is within a second sub-area of the second area, can include: in accordance with the start position and the end position, determining whether the start position is within the first sub-area of the second area and whether the end position is within the second sub-area of the second area.

The first sub-area and the second sub-area can be sub-sensing areas arranged along two borders of the first area opposite to each other. For example, in the example shown in FIG. 9, the operation body can shift along the direction shown by arrow A; that is to say, the first sub-area can be sub-area 921, and the second sub-area can be sub-area 923, and vice versa. Alternatively, the first sub-area can be sub-area 922, and the second sub-area can be sub-area 924, and vice versa.

Further, the first sub-area and the second sub-area can be sub sensing areas arranged along two borders of the first area adjacent to each other. For example, in the example shown in FIG. 9, the operation body can shift along the direction shown by arrow B; that is to say, the first sub-area can be sub-area 921, and the second sub-area can be sub-area 922, and vice versa. Alternatively, the first sub-area can be sub-area 923, and the second sub-area can be sub-area 924, and vice versa. FIG. 10 is a schematic diagram showing an exemplified case of in accordance with another example of the invention, determining, in the touch start point and the touch end point, whether there exists a first touch point that is located within a first sub-area of the second area and there exists a second touch point that is located within a second sub-area of the second area. Similarly to the electrical device 700 shown in FIG. 7, the electrical device 1000 includes a first area 1010 and a second area 1020 surrounding the first area 1010. As shown in FIG. 10, the second area is divided into sub-areas 1021 to 1024 in accordance with borders of the first area.

In the example shown in FIG. 10, the touch operation can be performed through a plurality of operation bodies at the same time. That in accordance with the start positions and/or the end positions, determining, in the touch start point and the touch end point, whether there exists a first touch point that is located within a first sub-area of the second area and there exists a second touch point that is located within a second sub-area of the second area, can include: in accordance with the start position, determining in the touch start point, whether there exists the first touch point that is located within the first sub-area of the second area and there exists the second touch point that is located within the second sub-area of the second area.

The first sub-area and the second sub-area can be sub-sensing areas arranged along two borders of the first area opposite to each other. For example, in the example shown in FIG. 10, while the first operation body shifts from the sub-area1021 to the first area 1010 along the direction shown by arrow C, the second operation body shifts from the sub-area1023 to the first area 1010 along the direction shown by arrow D. That is to say, the first sub-area can be sub-area 1021, and the second sub-area can be sub-area 1023, and vice versa (that is, the second sub-area can be sub-area 1021, and the first sub-area can be sub-area 1023). Alternatively, the first sub-area can be sub-area 1022, and the second sub-area can be sub-area 1024, and vice versa; no more will be described for brief. In this example, a plurality of operation bodies performing the touch operation at the same time refers to the time for the plurality of the operation bodies to perform touch operation at least partly overlaps.

Further, the first sub-area and the second sub-area can be sub-sensing areas arranged long two borders of the first area adjacent to each other. For example, in the example shown in FIG. 10, while the first operation body shifts from the sub-area 1021 to the first area 1010 along the direction shown by arrow C, the second operation body shifts from the sub-area 1022 to the first area 1010 along the direction shown by arrow E. That is to say, the first sub-area can be sub-area 1021, and the second sub-area can be sub-area 1022, and vice versa (that is, the second sub-area can be sub-area 1022, and the first sub-area can be sub-area 1021). Alternatively, the first sub-area can be sub-area 1023, and the second sub-area can be sub-area 1024, and vice versa; no more will be described for brief. As described above, in this example, a plurality of operation bodies performing the touch operation at the same time refers to the time for the plurality of the operation bodies to perform touch operation at least partly overlaps.

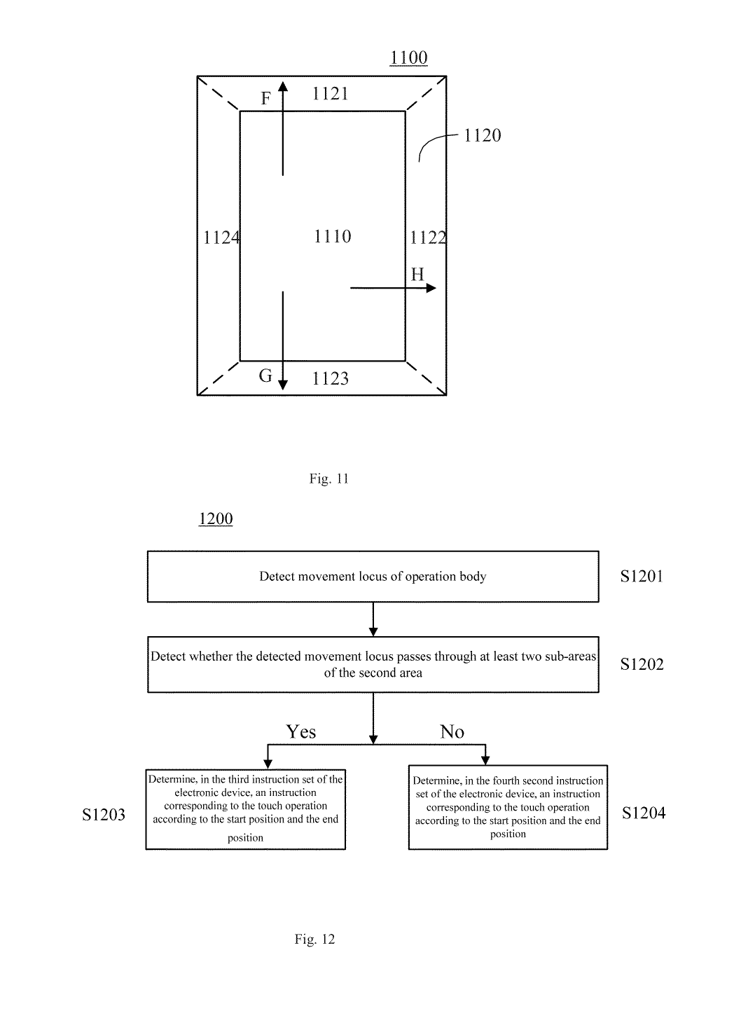

FIG. 11 is a schematic diagram showing an exemplified case of in accordance with another example of the invention, determining, in the touch start point and the touch end point, whether there exists a first touch point that is located within a first sub-area of the second area and there exists a second touch point that is located within a second sub-area of the second area. Similarly to the electrical device 700 shown in FIG. 7, the electrical device 1100 includes a first area 1110 and a second area 1120 surrounding the first area 1110. As shown in FIG. 11, the second area is divided into sub-areas 1121 to 1124 in accordance with borders of the first area.

In the example shown in FIG. 11, the touch operation can be performed through a plurality of operation bodies at the same time. That in accordance with the start positions and/or the end positions, determining, in the touch start point and the touch end point, whether there exists a first touch point that is located within a first sub-area of the second area and there exists a second touch point that is located within a second sub-area of the second area, can include: in accordance with the end positions, determining in the touch end point, whether there exists a first touch point that is located within the first sub-area of the second area and there exists a second touch point that is located within the second sub-area of the second area.

The first sub-area and the second sub-area can be sub-sensing areas arranged along two borders of the first area opposite to each other. For example, in the example shown in FIG. 11, while the first operation body shifts from the first area 1110 to the sub-area 1121 along the direction shown by arrow F, the second operation body can shift from the first area 1110 to the sub-area 1123 along the direction shown by arrow G. That is to say, the first sub-area can be sub-area 1121, and the second sub-area can be sub-area 1123, and vice versa (that is, the second sub-area can be sub-area 1121, and the first sub-area can be sub-area 1123). Alternatively, the first sub-area can be sub-area 1122, and the second sub-area can be sub-area 1124, and vice versa; no more will be described for brief. In this example, a plurality of operation bodies performing the touch operation at the same time refers to the time for the plurality of the operation bodies to perform touch operation at least partly overlaps.

Further, the first sub-area and the second sub-area can be sub-sensing areas arranged long two borders of the first area adjacent to each other. For example, in the example shown in FIG. 11, while the first operation body shifts from the first area 1110 to the sub-area 1121 along the direction shown by arrow F, the second operation body shifts from the first area 1110 to the sub-area 1122 along the direction shown by arrow H. That is to say, the first sub-area can be sub-area 1121, and the second sub-area can be sub-area 1122, and vice versa (that is, the second sub-area can be sub-area 1122, and the first sub-area can be sub-area 1121). Alternatively, the first sub-area can be sub-area 1123, and the second sub-area can be sub-area 1124, and vice versa; no more will be described for brief. As described above, in this example, a plurality of operation bodies performing the touch operation at the same time refers to the time for the plurality of the operation bodies to perform touch operation at least partly overlaps.

Returning to FIG. 8, when there exists a first touch point that is located within the first sub-area of the second area and there exists a second touch point that is located within the second sub-area of the second area, at step S803, in accordance with the start position and the end position, an instruction corresponding to the touch operation is determined in the second instruction set of the electrical device. And when in the touch start point and the touch end point, there fails to exist a first touch point that is located within the first sub-area of the second area and there exists a second touch point that is located within the second sub-area of the second area, at step S804, in accordance with the start position and the end position, an instruction corresponding to the touch operation is determined in the first instruction set of the electrical device.

In the example shown in FIG. 9, in operation interface such as application identification administration launch, the first instruction set can include instruction such as shifting application identification position, deleting application identification or the like, performed in current displayed page. And the second instruction set can include a cross-pages operation instruction such as page forward, page back or the like.

Further, in the example shown in FIG. 10 and FIG. 11, for example, in the image display/edit application, the first instruction set can include an instruction in which a rotate operation is performed in accordance with the touch locus of the operation body, and the second instruction set can include an instruction in which the current displayed image is zoomed in or out along the moving direction of the first operation body and the second operation body.

With the control method provided by above embodiments of the invention, the type of the touch control command can be increased, so as to satisfy the user's demand of various operations. And by arranging the areas of the electrical device as the first area and the second area surrounding the first area which includes a plurality of sub-areas, and classing the instructions corresponding to the touch operation in accordance with the position of the start point and the end point of the touch operation in the area, it is possible to reduce misjudgment of the electrical device to the user's touch input, and improve user's usage experience.

FIG. 12 is a flowchart describing a control method 1200 according to another embodiment of the invention. Hereinafter, the control method according to another embodiment of the invention will be described with reference to FIG. 12. The control method 1200 can be applied to the electrical device shown in FIG. 7.

As shown in FIG. 12, in Step S1201, a movement locus of an operation body is detected. Then, in step S1202, it is determined whether the movement locus detected in step S1201 passes through at least two sub-areas of the second area. For example, when the operation body passes through the sub-areas 721, 722 and 723 in sequence, it can be determined that the movement locus passes through at least two sub-areas of the second area.

When the movement locus passes through at least two sub-areas of the second area, in step S1203, in accordance with the movement locus, an instruction corresponding to the touch operation is determined in the first instruction set of the electrical device. In another example, when the movement locus fails to pass through at least two sub-areas of the second area, in step S1204, in accordance with the movement locus, an instruction corresponding to the touch operation is determined in the second instruction set of the electrical device.

With the control method provided by above embodiments of the invention, the type of the touch control command can be increased, so as to satisfy the user's demand of various operations. And by arranging the areas of the electrical device as the first area and the second area surrounding the first area which includes a plurality of sub-areas, and classing the instructions corresponding to the touch operation in accordance with the position of the start point and the end point of the touch operation in the area, it is possible to reduce misjudgment of the electrical device to the user's touch input, and improve user's usage experience.

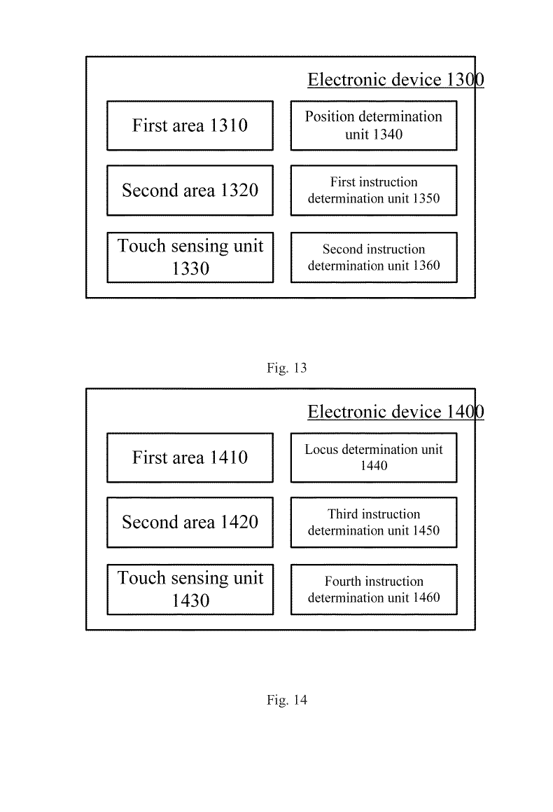

Hereinafter, the electrical device of an embodiment of the invention will be explained with reference to FIG. 13. FIG. 13 is a block diagram showing exemplified structure of an electrical device 700 according to an embodiment of the invention. As shown in FIG. 13, the electrical device of the embodiment can include a first area 1310, a second area 1320, a touch sensing unit 1330, a position determination unit 1340, a first instruction determination unit 1350 and a second instruction determination unit 1360. The respective units of the electrical device 1300 can perform the respective steps/functions of the display method of the FIG. 8 described above, thus no more will be described for brief of description.

For example, similarly to the electrical device 700 shown in FIG. 7, the second area 1320 is arranged to surround the first area 1310. The first area 1310 can be a polygon, and divide the second area 1320 into a plurality of sub-areas in accordance with borders of the first area 1310.

The touch sensing unit 1330 can detect the start position corresponding to the touch start point of the touch operation and the end position corresponding to the touch end point of the touch operation. The position determination unit 1340 can determine, in accordance with the start position and/or the end position, whether in the touch start point and the touch end point, there exists the first touch point that is located within the first sub-area of the second area and there exists the second touch point that is located within the second sub-area of the second area.

According to one example of the invention, the touch operation can be performed by one operation body. The position determination unit can determine, in accordance with the start position and the end position, whether the start position is located within the first sub-area of the second area and whether the end position is located within the second sub-area of the second area (for example, as shown in FIG. 9).

Alternatively, according to another example of the invention, the touch operation can be performed through a plurality of the operation bodies at the same time. The position determination unit can determine, in accordance with the start position, whether in the touch start point, there exists the first touch point that is located within the first sub-area of the second area and there exists the second touch point that is located within the second sub-area of the second area (for example, as shown in FIG. 10).

Alternatively, according to another example of the invention, the touch operation can be performed through a plurality of the operation bodies at the same time. The position determination unit can determine, in accordance with the end position, whether in the touch end point, there exists the first touch point that is located within the first sub-area of the second area and there exists the second touch point that is located within the second sub-area of the second area (for example, as shown in FIG. 11).

In this embodiment, the plurality of operation bodies performing the touch operation at the same time refers to the time for the plurality of the operation bodies to perform touch operation at least partly overlaps.

When there exists the first touch point that is located within the first sub-area of the second area and there exists the second touch point that is located within the second sub-area of the second area, the second instruction determination unit 1360 can determine, in the second instruction set of the electrical device, the instruction corresponding to the touch operation in accordance with the start position and the end position. On the other hand, when in the touch start point and the touch end point, there fails to exist the first touch point that is located within the first sub-area of the second area and there exists the second touch point that is located within the second sub-area of the second area, the first instruction determination unit 1350 can determine, in the first instruction set of the electrical device, the instruction corresponding to the touch operation in accordance with the start position and the end position.

With the electrical device provided by above embodiments of the invention, the type of the touch control command can be increased, so as to satisfy the user's demand of various operations. And by arranging the areas of the electrical device as the first area and the second area surrounding the first area which includes a plurality of sub-areas, and classing the instructions corresponding to the touch operation in accordance with the position of the start point and the end point of the touch operation in the area, it is possible to reduce misjudgment of the electrical device to the user's touch input, and improve user's usage experience.

Hereinafter, the electrical device according to an embodiment of the invention will be described with reference to FIG. 14. FIG. 14 is a block diagram showing an exemplified structure of the electrical device 1400 according to an embodiment of the invention. As shown in FIG. 14, the electrical device of the embodiment can include a first area 1410, a second area 1420, a touch sensing unit 1430, a locus determination unit 1440, a first instruction determination unit 1450 and a second instruction determination unit 1460. The respective units of the electrical device 1400 can perform the respective steps/functions of the display method of the FIG. 12 described above, thus no more will be described for brief of description.

For example, similarly to the electrical device 1300 shown in FIG. 13, the second area 1420 is arranged to be surround the first area 1410. The first area 1410 can be a polygon, and divide the second area 1420 into a plurality of sub-areas in accordance with borders of the first area 1410.

The touch sensing unit 1430 can detect the movement locus of operation body. The locus determination unit 1440 can determine whether the movement locus detected by the touch sensing unit 1430 passes through at least two sub-areas of the second area. In this embodiment, the touch operation can be performed by one operation body; alternatively, the touch operation can be performed through a plurality of operation bodies at the same time.

When the movement locus passes through at least two sub-areas of the second area, the first instruction determination unit 1450 can determine, in the first instruction set of the electrical device, an instruction corresponding to the touch operation in accordance with the movement locus. On the other hand, when the movement locus does not pass through at least two sub-areas of the second area, the second instruction determination unit 1460 can determine, in the second instruction set of the electrical device, an instruction corresponding to the touch operation in accordance with the movement locus.

With the electrical device provided by the embodiments of the invention described above, the type of the touch control command can be increased, so as to satisfy the user's demand of various operations. And by arranging the areas of the electrical device as the first area and the second area surrounding the first area, and dividing the second area into a plurality of sub-areas in accordance with borders of the first area, it is possible to reduce misjudgment of the electrical device to the user's touch input, and improve user's usage experience.

Further, in order to avoid user's operation of a false touch and further explicitly distinguish a touch operation which concerns edge area (that is, the second area) from a touch sensing operation which does not concern the edge area and is performed only at center area (that is, the first area), the width of the second area can be arranged to be narrow to avoid a false touch. Particularly, according to one example of the invention, the width of the second area can be arranged to be smaller than a predetermined value. For example, the predetermined value can be a distance from geometry center of the sensing area generated from the finger of ordinary user totally within the touch screen to the edge of this sensing area. The width of the second area is a distance from edge of the first area to the edge of the second area surrounding the first area. Furthermore, the electrical device corresponding to the embodiment of the invention can initially arrange the width value of the second touch area at time of shipment, this width value satisfies the above condition, the example of which is less than the distance from geometry center of the sensing area generated from the finger of ordinary user totally within the touch screen to the edge of this sensing area. Of course, the embodiment of the invention can adjust the width of the second touch area in accordance with the distance from geometry center of the sensing area generated from the finger of user totally within the touch screen to the edge of this sensing area, which is determined by the usage habit of the user (operation for several times) corresponding to the electrical device. Thus the user can have a great feeling about the operation experience of edge touch.

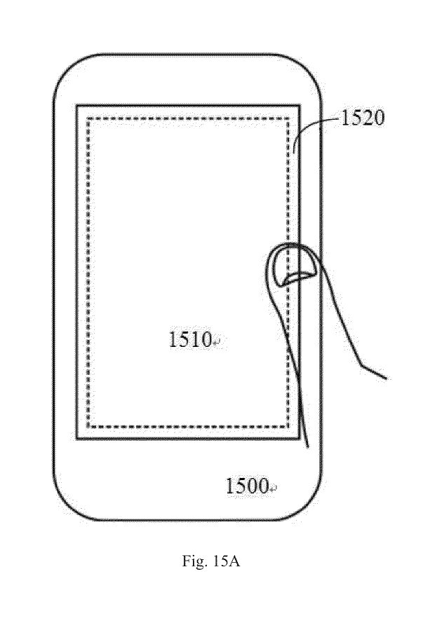

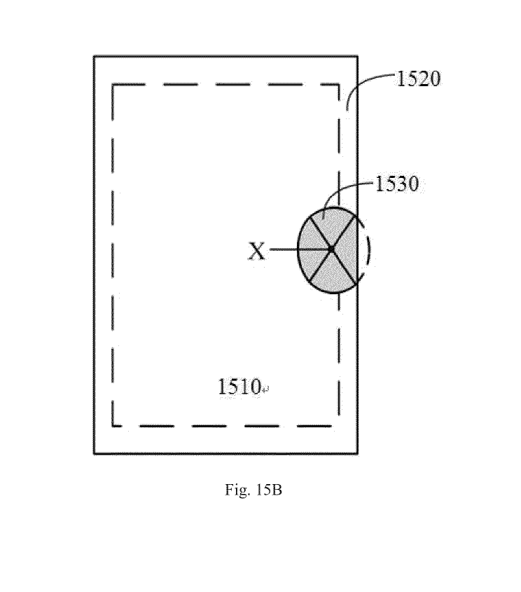

FIG. 15A and FIG. 15B are schematic diagrams showing user performing press operation at edge of a touch area when a second area is arranged to be narrow. As shown in FIG. 15A and FIG. 15B, an electrical device includes therein a first area 1510 and a second area 1520 surrounding the first area 1510, and the width of the second area 1520 is narrow. When the user performs press operation at the second area 1520 as shown in FIG. 15A, response to finger of the user generated by the touch sensing unit of the electrical device 1500 is shown in the response area 1530 of FIG. 15B. And the touch sensing unit determines the geometry center X of the response area 1530 to be the touch point by the finger. Therefore, in a case where the width of the second area 1520 is arranged to be narrow, even if the user touches the second area 1520 at time of performing press operation as shown in FIG. 15A, the touch sensing unit will not determine the touch position to be within the second area 1520. Thus a touch operation which concerns edge area (that is, the second area) is further explicitly distinguished from a touch sensing operation which does not concern the edge area and is performed only at center area (that is, the first area). That is to say, the width value is less than a distance value from the geometry center X of the response area 1530 on the touch sensing unit to the utmost outside of edges of the second area 1520 (that is, the utmost outside of edges of the touch area of the touch sensing unit overlapping with the display area of the display unit) when the user performs press operation at the second area 1520 as shown in FIG. 15A. Thus it is guaranteed the second area of the touch sensing unit can only sense the input gesture coming from the outside of the touch area of the touch sensing unit.

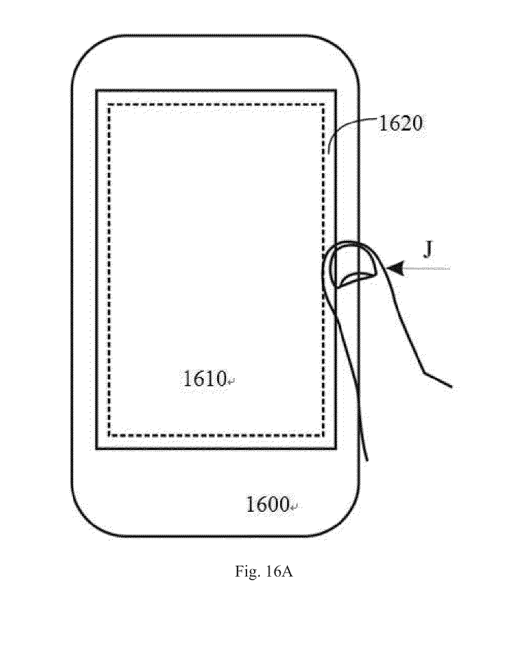

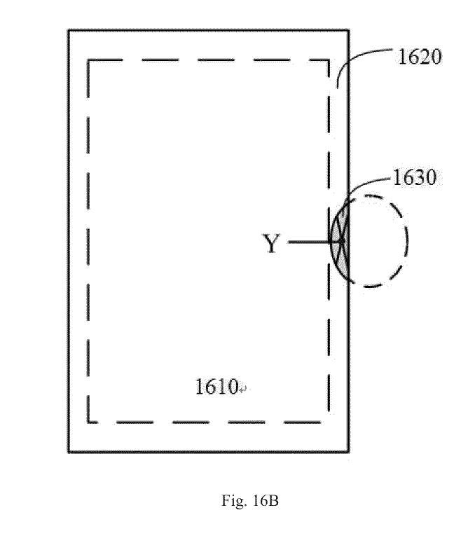

On the other hand, FIG. 16A and FIG. 16B are schematic diagrams showing user performing slide operation at edge of a touch area when a second area is arranged to be narrow. As shown in FIG. 16A and FIG. 16B, an electrical device 1600 includes therein a first area 1610 and a second area 1620 surrounding the first area 1610, and the width of the second area 1620 is narrow. When the user performs slide operation from the second area 1620 to the first area 1610 along a direction shown by arrow J as shown in FIG. 16A, response to finger of the user generated by the touch sensing unit of the electrical device 1600 is shown in the response area 1630 (grey area) of FIG. 16B. And the touch sensing unit determines the geometry center X of the response area 1630 to be the touch point by the finger. Therefore, even if the width of the second area 1620 is arranged to be narrow, when the user performs slide operation as shown in FIG. 16A, the touch sensing unit can determine that the finger shifts from the second area 1620 to the first area 1610. That is to say, since the width value of the second area is less than a distance value from the geometry center X of the response area 1530 on the touch sensing unit to the utmost outside of edges of the second area 1520 (that is, the utmost outside of edges of the touch area of the touch sensing unit overlapping with the display area of the display unit) when the user performs press operation at the second area 1520 as shown in FIG. 15A, when the user performs slide operation from the second area 1620 to the first area 1610 along a direction shown by arrow J as shown in FIG. 16A, response to finger of the user firstly generated by the second area 1620 of the touch sensing unit of the electrical device 1000 is shown in the response area 1630 (grey area) of FIG. 16B, and the touch sensing unit determines the geometry centerY of the response area 1630 to be the touch point by the finger (that is, a touch point of input gesture coming from outside of the touch area of the touch sensing unit).

It should be noted that, in this specification, the terms “comprising”, “including” or any other variant are intended to cover a non-exclusive inclusion, so that the process, method, article or device comprising a series of elements includes not only those elements, but also includes other elements not expressly listed, or further includes elements inherent in this process, method, article, or device. In the case of no more restrictions, the elements defined by the statement “includes a . . . ”, do not preclude the existence of additional identical elements in the process, method, article or device comprising the elements.

Finally, it should be noted that, the above-described series of processes comprise not only the processes performed in time series in the order described herein, but also comprise the processes performed concurrently or separately, instead of in chronological order.

Through the above description of the embodiments, the skilled in the art can clearly understand that the present invention can be implemented by means of software plus a necessary hardware platform; certainly, it can also be implemented entirely by hardware. Based on such understanding, all or part of the contribution of the technical solution of the present invention to the background art, may be embodied in the form of a software product, which can be stored in a storage medium, such as a ROM/RAM, hard disk, optical disk, etc., comprising a plurality of instructions for allowing a computer device (which may be a personal computer, a server, or a network device, etc.) to perform the methods described in various embodiments or in some portion of the embodiments of the present invention.

When units/modules are realized by software, in view of the level of existing hardware technology, without considering the cost, for the units/modules realized in software, those skilled in the art can construct corresponding hardware circuit to achieve corresponding function, said hardware circuit includes conventional Very Large Scale Integration (VLSI) circuit or gate array and semiconductor element such as logic chip, transistor or the like or other discrete element. Modules can be realized by programmable hardware device, such as field programmable gate arrays, programmable array logic, programmable logic device or the like.

The above has described the present invention in detail, and specific examples are used herein to explain the principles and embodiments of the invention. However, the above description of the embodiments is only used to help understanding the methods and core ideas of the present invention; meanwhile, for the ordinary skilled in the art, based on the ideas of the invention, variations can be made both in implementations and application ranges; in summary, the content of this specification should not be understood as limitative to the present invention.

1.-20. (canceled)

21. A touch input method for a touch sensing unit, the touch sensing unit including an input area which is divided into a first area and a second area that are not overlapped with each other, and a first edge of the input area coinciding with a second edge of the second area, wherein the second area can identify an input operation in which at least part of an operation object is in contact with the second edge, and the first area can identify an input operation in which the operation object is not in contact with the second edge, the touch input method comprising:
detecting a gesture input;
judging whether a start point of the gesture input is located within the first area or the second area so as to generate a judgment result;
generating a first command when the judgment result indicates that the start point of the gesture input is located within the first area;
generating a second command which is different from the first command when the judgment result indicates that the start point of the gesture input is located within the second area; and
executing the first command or the second command.

22. The touch input method according to claim 21, wherein the first command refers to an object operation command corresponding to the gesture input, the object operation command being used for operating the object, and the second command refers to a system administration command corresponding to the gesture input.

23. The touch input method according to claim 21, wherein
an end point of the gesture input is located within the first area or the second area when the start point of the gesture input is located within the first area; or
the end point of the gesture input is within the first area or the second area when the start point of the gesture input is within the second area.

24. The touch input method according to claim 21, wherein the second area refers to the edge of the first area and surrounds the first area.

25. The touch input method according to claim 21, wherein said generating the system administration command corresponding to the gesture input further comprises:
identifying type of the gesture input; and
generating a back command when the gesture input is identified to be a leftward slide operation in which the start point is located within the second area.

26. The touch input method according to claim 21, wherein the input gesture refers to a gesture coming from outside of the touch area of the touch sensing unit.

27. The touch input method according to claim 24, wherein a length of a second border of the second area perpendicular to the first edge is less than a first distance and greater than a second distance, and wherein when a physical touch imprint left by the finger is substantially identical to the first touch area sensed by the touch sensing unit, the touch sensing unit converts the first touch area to a first touch point and the distance from the first touch point to the first edge refers to the first distance, and when the physical touch imprint left by the finger is greater than the second touch area sensed by the touch sensing unit, the touch sensing unit converts the second touch area to a second touch point and the distance from the second touch point to the first edge refers to the second distance.

28. The touch input method according to claim 24, wherein the distance value from the divided boundary of the second area and the first area to the first edge of the input area of the touch sensing unit is less than the distance value from the first touch point to the first edge of the input area of the touch sensing unit corresponding to a case in which the edge of the first touch area is tangent with the first edge of the input area of the touch sensing unit.

29. An electrical device comprising:
a display unit for displaying an object of the electrical device on a display area;
a touch sensing unit arranged above the display unit and used to detect a gesture input, a touch area of the touch sensing unit being overlapped with the display area of the display unit, the touch area being divided into a first area and a second area that are not overlapped with each other;
a processor;
wherein the processor is configured to:
judge whether a start point of the gesture input is located within the first area or the second area so as to generate a judgment result;
generate a first command when the judgment result indicates that the start point of the gesture input is located within the first area;
generate a second command which is different from the first command when the judgment result indicates that the start point of the gesture input is located within the second area; and
execute the first command or the second command.

30. The electrical device according to claim 29, wherein the first command refers to an object operation command corresponding to the gesture input, the object operation command being used for operating the object, and the second command is a system administration command corresponding to the gesture input.

31. The electrical device according to claim 29, wherein the processor is further configured to:
identify type of the gesture input; and
generate a back command when the gesture input is identified to be a leftward slide operation in which the start point is located within the second area.

32. A control method for an electrical device including a first area and a second area surrounding the first area, wherein the first area is of polygon shape and the second area is divided into a plurality of sub-areas in accordance with borders of the first area, the first area and the second area constituting a touch sensing area corresponding to a touch sensing unit of the electrical device, the method comprising:
detecting movement locus of an operating body;
determining whether the movement locus passes through at least two sub-areas of the second area;
determining, in a first instruction set of the electrical device, an instruction corresponding to a touch operation in accordance with the movement locus when the movement locus passes through at least two sub-areas of the second area; and
determining, in a second instruction set of the electrical device, an instruction corresponding to the touch operation in accordance with the movement locus when the movement locus fails to pass through at least two sub-areas of the second area.

33. The method according to claim 32, wherein
the step of detecting the movement locus of the operating body further comprises:
detecting a start position corresponding to a touch start point of the touch operation and an end position corresponding to a touch end point of the touch operation; and
the step of determining whether the movement locus passes through at least two sub-areas of the second area further comprises:
in accordance with the start position and/or the end position, determining, in the touch start point and the touch end point, whether there exists a first touch point that is located within a first sub-area of the second area and there exists a second touch point that is located within a second sub-area of the second area;
in accordance with the start position and the end position, determining, in the second instruction set of the electrical device, the instruction corresponding to the touch operation when there exists the first touch point that is located within the first sub-area of the second area and there exists the second touch point that is located within the second sub-area of the second area; and
in accordance with the start position and the end position, determining, in the first instruction set of the electrical device, the instruction corresponding to the touch operation when there fails to exist the first touch point that is located within the first sub-area of the second area and there exists the second touch point that is located within the second sub-area of the second area.

34. The method according to claim 33, wherein
the touch operation is performed through one operation body;
that in accordance with the start position and/or the end position, determining, in the touch start point and the touch end point, whether there exists the first touch point that is located within the first sub-area of the second area and there exists the second touch point that is located within the second sub-area of the second area including:
in accordance with the start position and the end position, determining whether the start position is located within the first sub-area of the second area and whether the end position is located within the second sub-area of the second area.

35. The method according to claim 33, wherein
the touch operation is performed through a plurality of operation bodies at the same time;
that in accordance with the start position and/or the end position, determining, in the touch start point and the touch end point, whether there exists the first touch point that is located within the first sub-area of the second area and there exists the second touch point that is within the second sub-area of the second area including:
in accordance with the start position, determining, in the touch start point, whether there exists the first touch point that is located within the first sub-area of the second area and there exists the second touch point that is located within the second sub-area of the second area.

36. The method according to claim 33, wherein
the touch operation is performed through a plurality of operation bodies at the same time;
that in accordance with the start position and/or the end position, determining, in the touch start point and the touch end point, whether there exists the first touch point that is within the first sub-area of the second area and there exists the second touch point that is within the second sub-area of the second area including:
in accordance with the end position, determining, in the touch end point, whether there exists the first touch point that is located within the first sub-area of the second area and there exists the second touch point that is located within the second sub-area of the second area.

37. The method according to claim 33, wherein the first sub-area and the second sub-area are sub-areas adjacent to each other.

38. An electrical device comprising:
a touch sensing unit configured to detect movement locus of operation body, wherein a touch sensing area of the touch sensing unit is divided into a first area and a second area, the second area surrounding the first area, wherein the first area is a polygon and the second area is divided into a plurality of sub-areas in accordance with borders of the first area;
a locus determination unit configured to determine whether the movement locus passes through at least two sub-areas of the second area;
a first instruction determination unit configured to determine, in a first instruction set of the electrical device, an instruction corresponding to the touch operation in accordance with the movement locus when the movement locus passes through at least two sub-areas of the second area; and
a second instruction determination unit configured to determine, in a second instruction set of the electrical device, an instruction corresponding to the touch operation in accordance with the movement locus when the movement locus fails to pass through at least two sub-areas of the second area.

39. The electrical device according to claim 38, wherein
the touch sensing unit is configured to detect a start position corresponding to a touch start point of the touch operation and an end position corresponding to a touch end point of the touch operation;
the electrical device further includes a position determination unit configured to determine, in the touch start point and the touch end point, whether there exists a first touch point that is located within a first sub-area of the second area and there exists a second touch point that is located within a second sub-area of the second area, in accordance with the start position and/or the end position;
the second instruction determination unit is configured to determine, in the second instruction set of the electrical device, the instruction corresponding to the touch operation when there exists the first touch point that is located within the first sub-area of the second area and there exists the second touch point that is located within the second sub-area of the second area, in accordance with the start position and the end position; and
the first instruction determination unit is configured to determine, in the first instruction set of the electrical device, the instruction corresponding to the touch operation when there fails to exist the first touch point that is located within the first sub-area of the second area and there exists the second touch point that is located within the second sub-area of the second area, in accordance with the start position and the end position.

40. The electrical device according to claim 39, wherein the touch operation is performed through one operation body; and the position determination unit determines whether the start position is located within the first sub-area of the second area and whether the end position is within the second sub-area of the second area, in accordance with the start position and the end position.

41. The electrical device according to claim 39, wherein
the touch operation is performed through a plurality of operation bodies at the same time; and
the position determination unit determines, in the touch start point, whether there exists the first touch point that is located within the first sub-area of the second area and there exists the second touch point that is located within the second sub-area of the second area, in accordance with the start position.

42. The electrical device according to claim 39, wherein
the touch operation is performed through a plurality of operation bodies at the same time; and
the position determination unit determines, in the touch end point, whether there exists the first touch point that is located within the first sub-area of the second area and there exists the second touch point that is located within the second sub-area of the second area, in accordance with the end position.
